(19) United States
(12) Patent Application Publication
(10) Pub. No.: US 2008/0236194 A1
(43) Pub. Date: Oct. 2, 2008

(54) Cryogenic Flow Valve System

(76) Inventors: Vladimir Mikheev, Oxon (GB); Paul Geoffrey Noonan, Oxfordshire (GB); Nicholas Fairburn Walkington, Oxfordshire (GB)

Correspondence Address: BLANK ROME LLP, 600 NEW HAMPSHIRE AVENUE, N.W., WASHINGTON, DC, 20037, US

(21) Appl. No.: 11/663,453

(22) PCT Filed: Sep. 20, 2005
(86) PCT No.: PCT/GB05/03596

§ 371 Date: Jan. 4, 2008

(30) Foreign Application Priority Data
Sep. 22, 2004 (GB) 0421111.6

(51) Int. Cl. F25J 3/00; F16K 31/126

(52) U.S. Cl. 62/639; 220/560.08; 251/61.1

(57) ABSTRACT

A cryogenic flow valve system for controlling the flow of a cryogenic fluid is disclosed. The system has a valve and an adsorption pump. The valve includes a flow chamber and a moveable member. The cryogenic fluid flows the flow chamber, and the moveable member is in contact with a control fluid. The position of the moveable member controls the flow in the flow chamber. The pressure of the control fluid controls the position of the moveable member. The adsorption pump includes a chamber and a heater. The chamber is in contact with the moveable member and contains an adsorption material for retaining control fluid. The heater heats the adsorption material to control the pressure of the control fluid.

The present invention relates to a cryogenic flow valve system for controlling the flow of a cryogenic fluid.

There exists a need in many cryogenic devices to regulate the flow of a cryogenic fluid (liquid or vapour). For example, it is often desired to regulate the flow of cryogen from a vessel at higher pressure to one at lower pressure via a valve with an adjustable opening. An example is the lambda-point refrigerator which is often used to cool superconducting magnets to temperatures below 4.2K, (the ambient pressure boiling temperature of helium).

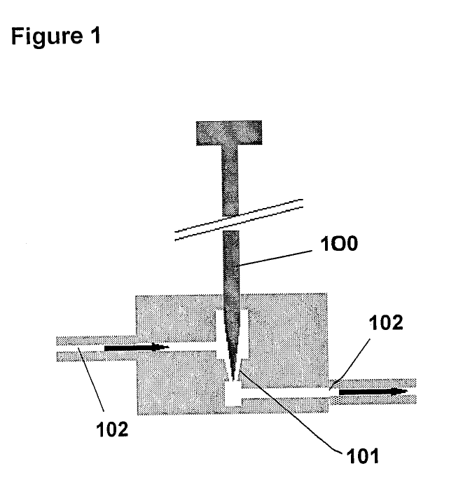

Conventionally a needle-valve is used to control the flow of helium in the refrigerator circuit. An example is shown in FIG. 1 where a tapered needle moves in and out of a shaped orifice 101, regulating the flow of cryogen 102 through the orifice. Unfortunately, this device has a number of problems, such as:—
sticking/mechanical damage due to over-tightening;
blockages;
backlash (causing hysteresis) and difficulty making fine adjustments; and
a long control shaft that must extend outside the cryostat (causing a heat leak and requiring substantial extra mechanical complexity in the cryostat design).

Replacing a malfunctioning needle-valve is an expensive and lengthy procedure. Indeed some high-field magnet cryostats have to be cut open in field to replace such valves. To mitigate these problems, a second needle-valve is often fitted to provide redundancy, but at increased expense.

In some applications it is also known to use diaphragm valves in which a flexible diaphragm is distorted by a pressure differential so as to impede the flow path within the valve. The pressure is regulated in this case using a pressurised gas bottle, regulator and pressure release system. However, the use of such a pressure system does not lend itself to the control of fluids at cryogenic temperatures. The apparatus is also bulky, positioned external to the cryostat and requires replenishment with gas since this is lost to atmosphere by repeated use of the valve.

There is therefore a need to produce a simple and reliable cryogenic valve with good performance properties and which addresses each of the problems mentioned above.

In accordance with the invention we provide a cryogenic flow valve system for controlling the flow of a cryogenic fluid, the system comprising:—

a valve having a flow chamber through which the cryogenic fluid is caused to flow when in use; and a moveable member the position of which controls the flow in the flow chamber, wherein the moveable member is arranged in communication with a control fluid such that the position of the moveable member is controlled in use in accordance with the pressure of the control fluid; and

an adsorption pump comprising a chamber containing adsorption material for retaining at least some of the control fluid when in use, the chamber being in fluid communication with the moveable member; and a heater for heating the adsorption material so as to control the pressure of the control fluid.

We have realised that many of the known problems in prior art cryogenic valve systems can be overcome by the combination of a valve which is operated using a control fluid, specifically by controlling the pressure of the fluid; and the use of an adsorption pump which contains at least some of the control fluid; and in which the pressure is controlled by regulating the temperature of the adsorption material using a heater. A suitable control system is provided to control the heater. The use of an adsorption pump to control a valve represents a novel use for this type of device, the normal use of which is of course for cooling purposes.

The system of the present invention provides numerous advantages over the prior art valves. In particular, the use of the adsorption pump with associated heater provides a means of controlling the pressure of the control fluid and allows the provision of a sealed system in which no control fluid is lost and also in which the number of moving parts is minimised. A reduction in the number of moving parts is particularly advantageous at low temperatures since lubrication, component brittleness and heating problems are avoided. Many low temperature systems are also deliberately operated at such temperatures to ensure low noise levels which can be caused by mechanical vibrations from moving parts.

Since the valve controls the flow of cryogenic fluid, this is typically positioned within a cryostat or analogous apparatus, as is the adsorption pump. The cryostat may therefore act as a cooling system for the control fluid of the adsorption pump, although a separate cooling system is also envisaged. Unlike in prior art systems, the heater wiring provides the only thermal leak path for the valve, out of the low temperature region of the cryostat. This is a significant improvement upon for example a control shaft for a needle valve. The valve and adsorption pump are typically connected by a suitable conduit such as a pipe which provides control fluid communication between these components.

It is particularly beneficial in a cryogenic environment to use the adsorption material of an adsorption pump so as to adsorb/desorb the control fluid. The temperature-dependent adsorption characteristics of this material are used to regulate the pressure. The heater is arranged to heat the adsorption material in a known manner. Specifically, as the temperature of the adsorption material is changed, the fraction of cryogenic fluid in the volume that is adsorbed within the adsorption material varies, and hence the pressure changes accordingly.

The cooling may be provided by a thermal link with a low thermal conductance. Accordingly, the temperature of the adsorption material is controlled by the heater and thermal link in combination. The use of an electrical heater allows the flow of the cryogen in the valve to be adjusted with high accuracy and reliability.

Although not essential, it is advantageous for the control of cryogenic fluids to ensure that the cryogenic fluid and the control fluid are the same type of fluid. The cryogenic fluid may be in the form of a liquid or a gas. Typically this will be helium-4, although it may be helium-3, nitrogen, and so on. During use, the control fluid in part of the system distal from the adsorption pump may be in the liquid phase, with the remainder being in the gaseous phase. It is important to ensure that no control fluid in liquid form reaches the adsorption pump. The part of the control fluid in contact with the moveable member may be either a gas or a liquid.

The flow chamber of the valve may take a large number of geometric forms although of course these will typically each have one or more input and output ports to effect the cryogenic fluid flow. The flow chamber may therefore be an expansive volume, an elongate tube, a disc, cylinder or any other shape required by the application.

Typically the valve further comprises a control chamber for containing at least some of the control fluid which acts upon the moveable member. The control chamber is therefore arranged in communication with the control device. The control chamber may therefore take any desired form suitable for the application, although this is likely to be dependent upon the geometry of the flow chamber. For example if the flow chamber is disc shaped then the control chamber may have a shape with circular symmetry, whereas if the flow chamber is in the form of a tube then the control chamber may likewise be a tube, these being arranged coaxially for example. Multiple flow and control chambers are also envisaged.

Typically the control chamber has a variable volume in accordance with the pressure of the control fluid. This may be achieved by the use of resilient materials. Alternatively or in addition, the walls of the control chamber may comprise bellows to effect the variable volume.

The movable member itself may comprise a substantially rigid plate or disc which, in use, is arranged to be brought into contact with a wall of the flow chamber so as to control the flow in the flow chamber. Such a moveable member may be provided with a polymer layer upon its surface (such as polyimide) which has flexibility at cryogenic temperatures.

The moveable member may take the form of a flexible membrane. In the case of the provision of flow and control chambers, this membrane may preferably separate the interiors of flow and control chambers. Indeed the flow and control chambers may be formed from a single chamber, divided by the flexible membrane so as to provide the two chambers. For low temperature use, such as at 4.2 Kelvin, the flexible membrane is preferably formed from polyimide or any other suitable material with good flexibility even at such low temperatures.

One or each of the flow and control chambers may be subdivided into sub-chambers. The flow chamber may therefore comprise first and second connected flow sub-chambers between which the cryogenic fluid is arranged to flow. The control chamber may also comprise first and second corresponding connected control sub-chambers each of these being related to a respective flow sub-chamber. The moveable member may also comprise first and second corresponding flexible membranes, one such membrane being provided to control the flow in each respective flow and control sub-chamber. The flexible membranes may therefore be separate components with the term “moveable member” being intended to encompass a number of such members.

In the sub-chamber arrangement, the input port(s) is arranged to open into one flow sub-chamber, with the output port(s) opening into the second flow sub-chamber. Preferably a flow conduit is positioned between the flow sub-chambers to provide a flow path between them. Preferably the sub-chambers are arranged such that the flow sub-chambers are each sandwiched between the first and second control sub-chambers. Each of the sub-chambers may be located within a housing of the valve, and the walls of the housing may comprise walls of at least the first and second control sub-chambers. For sandwiched flow sub-chambers, the flow sub-chambers are preferably arranged in the centre of the housing between the corresponding control sub-chambers.

In one example, the sub-chambers are arranged having approximate disc shapes when in use (depending upon the control fluid pressure), thereby having a narrow height and a relatively large diameter. The input port(s) is positioned at a first radial position with respect to the disc centre with the output port(s) disposed in the other sub-chamber at a substantially similar radial position, diametrically opposed from the first. The cryogenic fluid may therefore flow throughout the interior of the disc and generally across its diameter in each sub-chamber and pass between the sub-chambers through a conduit which passes down the centre of the discs. The flexible membrane in each case may therefore also be arranged as a circle, corresponding to that of the discs.

This arrangement provides the advantageous property of allowing the valve dimensions to be made smaller than the flow path length. Generally the flow impedance increases as a function of the length of the flow path and decreases as a function of its cross-section. This reduces the likelihood of blockages by foreign objects and ensures that the flow is substantially laminar. Turbulent flow is preferably avoided. Note that the flow path length in a typical needle-valve is less then 1 millimetre, whereas in the present invention it may be a number of centimetres.

Typically the cryogenic fluid whose flow is to be controlled is at about atmospheric pressure (about 100 kilopascals) on one side of the valve, and a few pascals on the other. Typically the control fluid operational pressures may be between about 50 kilopascals and a few hundred kilopascals (atmospheric pressure or more).

The present invention therefore provides a reliable and finely controllable cryogenic valve system with no moving parts (at least within the adsorption pump), the possibility of retaining all of the control fluid and use at the very lowest cryogenic temperatures.

Some examples of cryogenic flow path systems according to the present invention are now described, with reference to the accompanying drawings, in which:—

FIG. 1 is a schematic illustration of a prior art needle-valve;

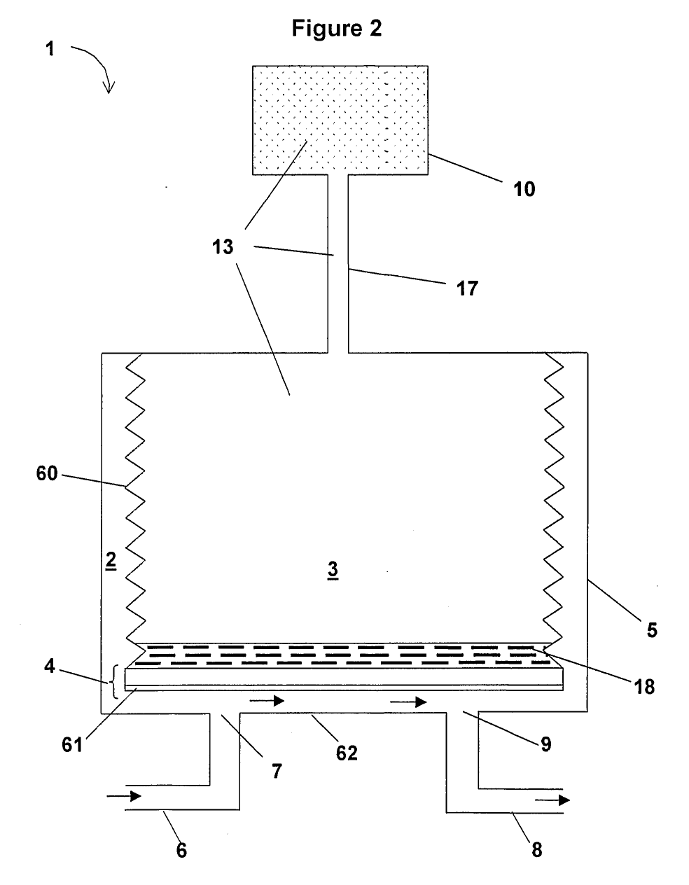

FIG. 2 is a schematic representation of a section through a first example of the invention;

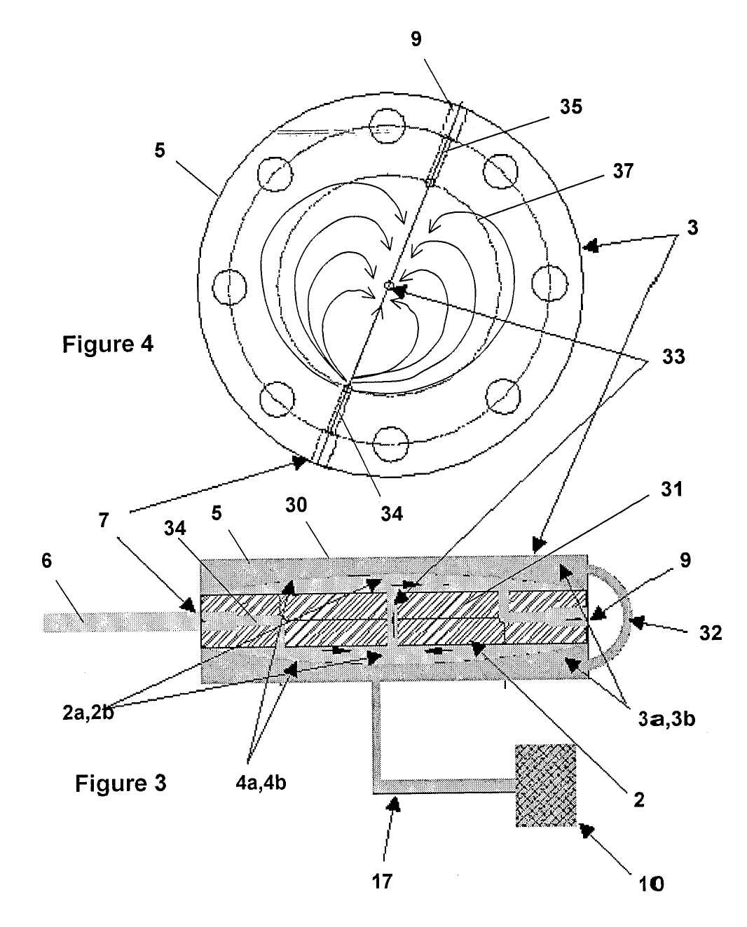

FIG. 3 is an illustration of apparatus according to the second example of the invention; and

FIG. 4 is a schematic view of the second example from above.

Referring now to FIG. 2, a cryogenic flow valve system according to a first example of the invention is shown generally illustrated (schematically) at 1, for controlling the flow of helium-4 within part of a cryostat (not shown). The system 1 comprises a flow chamber 2 formed from a cylindrical housing within which is positioned a control chamber 3 of controllably variable volume. The walls of the chamber 3 are formed from bellows 60 which may be formed for example from metallic edge-welded rings. One end of the bellows 60 are mounted and sealed to an upper wall of the chamber 2, with the opposite end being sealed by a metallic disc 4 which acts as a moveable member in accordance with compression or expansion of the bellows 60. The bellows 60 therefore allow the distance between the respective ends of the control chamber 3 to be varied.

Optionally, the part of the disc 4 external to the chamber 3 may be provided with a layer 61 formed from a material such as polyimide or other material that remains flexible at low temperatures.

The chambers 2, 3 and flexible membrane 4 form a cryogenic valve 5.

A cryogenic fluid supply conduit 6 provides cryogenic fluid 7 in the form of liquid helium-4 (at 4.2 Kelvin in this case), to the flow chamber 2 through an input port 7 in a bottom flat wall 62 of the flow chamber 2. Since the valve 5 is used to control the flow of cryogenic fluids, it is typically positioned in a cryostat when in use. In another part of the wall 62, an output conduit 8 is provided which connects with the flow chamber via an output port 9. The surface of the wall 62 on the inside of the chamber 2 is highly polished.

An adsorption pump 10 (“sorb”) is provided, this being in fluid communication with the interior of the control chamber 3 via a pipe 17 which enters the chamber 3 through a port in the housing at the opposite end of the chamber 3 to the disc 4. As will be understood, the sorb 10 contains finely divided “activated” carbon powder (having a large surface area) upon which atoms/molecules of a gas can be controllably adsorbed, the degree of adsorption being strongly dependent upon the temperature of the carbon. An integral heater is provided within the sorb to effect the temperature control. When the sorb 10 is placed in communication with a fixed amount of gas, the pressure of the gas can be controlled in accordance with the temperature of the carbon. The pipe 17 and sorb 10 are also positioned within the cryostat at a suitably low temperature location. A thermal link is provided between the sorb 10 and a cool part of the cryostat. Therefore the cryostat provides cooling of the powder within the sorb 10, whereas the integral heater provides any required heating such that the temperature of the carbon can be controlled accurately.

When in use, the control chamber 3 and pipe 17 are filled with a control fluid 13 and the pressure of the fluid inside the control chamber 3 is controlled using the heater within the sorb 10. The term “fluid” herein encompasses gases and liquids for the reasons now described.

In the present example the control fluid is helium-4. This is primarily in gaseous form. However, there exists a temperature gradient in the control fluid “side” of the system. This is because, at the location of the disc 4, the temperature is substantially 4.2 Kelvin (since this is the temperature of the liquid in the flow chamber 2), whereas the temperature in the adsorption pump may be between about 1 and 40 Kelvin when the system is in use and most of the helium-4 gas is desorbed due to the operation of the heater. Since some of the control fluid is at substantially 4.2 Kelvin then, depending upon the pressure, some of the control fluid 13 adjacent the disc 4 may be in liquid form. This is indicated at 18 in FIG. 2, the level of the liquid being schematic. For this reason the sorb 10 is positioned at a higher location than the valve (or at least an intermediate part of the pipe 17 is higher) to prevent liquid control fluid entering the sorb 10.

Systems in which part or none of the control fluid is in gaseous form are each envisaged. Whether or not some of the control fluid is liquid at any time during use is dependent upon the operational pressure ranges of the fluids in the flow 2 and control 3 chambers, and indeed the choice of fluids in each respective chamber (note these need not necessarily be the same).

As indicated by the arrows in the conduits 7, 8, and the flow chamber 2, when in use the cryogenic fluid 7 is caused to flow from the supply conduit 6 through the flow chamber 2 and through the output conduit 8. The disc 4 in FIG. 2 is shown in the “open” position. This is effected by a relatively low pressure of the control fluid 13,18 corresponding to a low temperature of the carbon within the sorb 10. In such a position the cryogenic fluid flow experiences little impedance on passing between the input and output ports 7, 9. As shown in FIG. 2, a gap exists between the bellows 60 and the adjacent walls of the control chamber 2. The size of the gap varies in use dependent upon the extension of the bellows 60. However, there is preferably no contact between the bellows 60 and the adjacent walls.

When it is desired to restrict or complete y impede the flow of cryogenic fluid in the chamber 2, so as to cause a pressure differential to exist between the fluid at ports 7 and 9, the sorb heater is operated so as to raise the pressure within the control chamber 3. This increase in pressure causes the disc 4 to be moved towards the wall 62 (allowed by the movement of the bellows 60), thereby narrowing the path between the input and output ports 7,9.

As the outer surface of the disc impacts against the surface 62, the path between the ports 7, 9 becomes impeded until the fluid is unable to pass between the ports and the valve 5 is then in the “closed” position. A good fluid seal can be provided by either ensuring that the disc surface is polished (and impacts against the polished surface of the wall 62), or by the use of the layer of polymer shown in FIG. 2. This is sufficiently compressible and non-permeable to the fluid to ensure a good seal is achieved.

Only a relatively small amount of movement of the disc 4 is actually required to move the disc 4 from a substantially fully open to a fully closed position in the present example. The shape of the chambers 2, 3 can of course be modified to control the degree of movement required. The response time of the system also depends particularly upon the size of the chamber 3, pipe 17, the sorb 10 and indeed the operational pressure of the gas 13.

When the system is at a relatively high pressure following the use of the heater, in order to return the valve to the fully “open” position, the sorb heater current is switched off and the sorb 10 is cooled by the refrigerating action of the cryostat, with the control fluid pressure reducing accordingly as the fluid is adsorbed.

A second example of the invention is illustrated in FIGS. 3 and 4. Here analogous components to those of the first example are provided with similar reference numerals.

In this case a valve 5 takes the general form of an oblate cylinder. The walls of the cylinder form a housing 30. A metallic disc member 31 is positioned in the centre of the cylinder, this being circular, having a thickness about half the length of the cylinder and being aligned in a coaxial manner with the cylinder. The disc member 31 divides the internal volume of the cylindrical valve 5 into two separate volumes.

A first flexible disc membrane 4a is provided, formed from resilient polyimide, this having the general form of a circular sheet. The membrane 4a is mounted to the circumference of the disc member 31 in a sealed manner so as to seal any fluid on one side of the disc membrane 4a from any upon the other. A similar disc membrane 4b is provided on the opposed surface of the disc member 31. The disc member 31 is therefore sandwiched between the two flexible disc membranes 4a, 4b. The volume between the flexible disc 4a and its respective disc member surface forms a flow sub-chamber 2a and similarly a flow sub-chamber 2b is formed with the other flexible disc membrane 4b and the opposed surface of the disc member 31.

On the other side of the flexible disc membrane 4a, between this and the wall of the housing 30, a volume is defined which constitutes a control chamber 3a. Similarly a control chamber 3b can be found in the corresponding position on the opposing side of the disc member 31 between the flexible disc membrane 4b and the wall of the housing 30.

The control chamber 3a and 3b are linked by a connection conduit 32 so as to equalise the pressure between these two sub-chambers. A central conduit 33 connects the opposing faces of the disc member 31 and joins the two flow sub-chambers 2a, 2b together. A input port 7 is provided at a location such that the supply conduit 6 passes through the wall of the housing 30 and directly inside the disc member 31, where an input flow conduit 34 is positioned to transport the cryogenic fluid into the first flow sub-chamber 4a. At a position diametrically opposed to the input port, an output port 9 connects the interior of the disc member 31 to the output conduit 8 (not shown) and a corresponding output flow conduit 35 connects the flow sub-chamber 2b to the output conduit 8.

The respective arrangements of the input and output ports 7, 9 and input and output flow conduits 34, 35 are illustrated in FIG. 4 which is a schematic illustration of the valve 5 when viewed from above.

Returning to FIG. 3, as is illustrated, the pipe 17 connects the control sub-chamber 3a to an adsorption pump (sorb) 10 with an electrical heater integrated within the sorb. The sorb 10 is again cooled with a thermal link to the cryostat (not shown) in which the apparatus is located. The sorb 10 is preferably placed at a location above the valve to prevent any control fluid entering the sorb in liquid form. Whether or not any of the control fluid is in the liquid phase is application dependent.

The adsorbent material in the present example is again activated carbon powder. This material has a high surface area and is chosen for its ability to adsorb the cryogenic control gas. This is advantageous since the pressure of the helium-4 control gas within the control chambers 3a, 3b, pipe 17 and sorb 10 is strongly dependent upon the temperature of the adsorption material. Thus by varying the temperature of the adsorbent material a large pressure variation can be achieved.

Referring once again to FIGS. 3 and 4, in use the cryogenic fluid to be controlled flows from the supply conduit 6 through the input flow conduit 34 within the disc member 31 and then passes into the flow sub-chamber 2a, one wall of this being provided by the flexible disc member 4a. As shown by the arrows in FIG. 4, although a single fluid input location is used, the cryogenic fluid flows within the disc shaped volume and then passes through the central conduit 33 to the second flow sub-chamber 2b.

Once the cryogenic fluid has passed through the central conduit 33, it again flows in a similar manner within the second flow sub-chamber 2b and exits the valve through the output flow conduit 35 and output conduit 9.

The pressure differential between the cryogenic fluid and the control fluid in the control sub-chambers 3a, 3b, together with the form of the flexible disc membranes 4a, 4b themselves, dictates the shape of the flow sub-chambers 2a and 2b. The shape of the membranes is dependent upon the pressure due to the resilience of the polyimide.

A particular advantage of the arrangement as embodied in the present example is that the cryogenic fluid flow path is folded back upon itself. This allows the valve dimensions to be made smaller than the flow path length. It is important that the flow path length is substantially longer than the cross-section of the flow path. A long path allows a larger cross-sectional flow area for the same impedance, which reduces the likelihood of blockages by foreign objects. This improves the reliability of the valve. Furthermore, if the flow path is long then the flow will be substantially laminar. Turbulent flow is to be avoided if possible since this can cause damage due to cavitation effects associated with supersonic flow, and also unpredictable phase changes in the fluid.

As the pressure of the control fluid in the control sub-chambers 3a and 3b rises in comparison with that of the flow sub-chamber 2a, 2b, the two membranes 4a, 4b will distort simultaneously under the influence of the differential pressure across them. This constricts the cross-sectional area of the flow path thereby increasing the flow impedance. Note that a membrane of uniform stiffness clamped around its circumferential edge will tend to distort into a parabolic shape under the influence of differential pressure and this causes a local constriction of the flow path near the central conduit 33. This leads to a somewhat non-linear relationship between the flow rate and the control pressure. However, it is desirable to increase the linearity of this relationship so as to improve the preciseness of the control that can be achieved.

It is possible to improve this linearity by locally adjusting the stiffness of the membrane 4a, 4b. If the central region of the membrane is stiffened, for example by doubling the thickness of the central part of each of the membranes 4a, 4b, then most of the distortion will occur in the annulus of weakened material around the edge of the membranes 4a, 4b. A doubled thickness of the membrane in each case can be achieved simply by adhering a disc of similar thickness material to the membrane in question. FIG. 4 illustrates the provision of a double thickness central portion of the disc membranes 4a and 4b at 37. Note that the input and output flow conduits 34, 35 open into the respective flow sub-chambers 2a and 2b at the edge of this strengthened disc section 37. The central stiffer region of each membrane will then displace more uniformly across the circular flow chamber, giving a more linear relationship between flow and control pressure.

Note also that the volume comprising the control sub-chambers, the volume within the sorb and the pipe 17 is a sealed (closed) volume. This is therefore charged initially with the control fluid at manufacture with a predetermined quantity of this fluid. This may be topped up at a later date if required.

As in the previous example, the sorb 10 is cooled by thermally linking it to a cold part of the cryostat, this link having a low thermal conductivity to minimise the heat leak when the sorb 10 is being heated. As is mentioned above, the sorb is provided with a small electrical heating element which, when operated heats the adsorption chamber and the material within it, without it adding a significant heat load to the cryostat. When the heater is not in operation, the sorb cools to the same temperature as the part to which it is thermally linked.

By varying the power to the electrical heater, it is possible to adjust the temperature of the sorb, typically in the range 1 to 40 Kelvin. At the cold end of this range, the adsorption material strongly adsorbs the majority of the control gas thereby creating a low pressure. When at the hot end, the adsorption material expels this fluid creating a high pressure. In this way it is possible to control the pressure in the sorb and hence the opening of the valve, electrically, simply by adjusting the current to the heater element.

By careful design it is possible to obtain an approximately linear relationship between a common control pressure and an electrical parameter of the heater such as the voltage, current or power. The response of the valve opening to the heater current can therefore be made to be approximately linear and the time lag between activation of the sorb heater and the flow adjustment can be minimised by careful design of the heater and the cold link.

Although discussed in detail here, any suitable control system may be used to control the valve by effecting control of the power dissipation in the electrical heater of the sorb 10. As an example, a computer system with appropriate feedback sensors can be used.

Note that, the present invention is particularly advantageous in comparison with prior art needle-valves, in that the present invention suffers almost no hysteresis in comparison with the prior art. It can be used in the place of such valves and allows much finer adjustment of the flow. No mechanical links to the outside of the cryostat are required, merely electrical connections and this simplifies the design and reduces complexity, cost and heat leaks. The large cross-sectional area of the flow path prevents the chance of blockage by foreign objects and this improves reliability and largely obviates the need to open the cryostat to replace the valve or indeed to fit several valves for redundancy.

1. A cryogenic flow valve system for controlling the flow of a cryogenic fluid, the system comprising:
a valve having a flow chamber through which the cryogenic fluid is caused to flow when in use; and a moveable member the position of which controls the flow in the flow chamber, wherein the moveable member is arranged in communication with a control fluid such that the position of the moveable member is controlled in use in accordance with the pressure of the control fluid; and
an adsorption pump comprising a chamber containing adsorption material for retaining at least some of the control fluid when in use, the chamber being in fluid communication with the moveable member; and a heater for heating the adsorption material so as to control the pressure of the control fluid.

2. A system according to claim 1, further comprising a cooling system adapted to cool the adsorption material.

3. A system according to claim 1, further comprising a pipe to provide control fluid communication between the adsorption pump and the moveable member.

4. A system according to claim 1, wherein during use, the control fluid in part of the system distal from the adsorption pump is in the liquid phase.

5. A system according to claim 1, wherein the cryogenic fluid and the control fluid are similar fluids.

6. A system according to claim 1, wherein the valve is adapted to control the flow of liquid cryogenic fluid.

7. A system according to claim 1, wherein the valve is adapted to control the flow of gaseous cryogenic fluid.

8. A system according to claim 1, wherein the cryogenic fluid is helium-4 or helium-3.

9. A system according to claim 1, wherein part of the control fluid which contacts the moveable member is a gas.

10. A system according to claim 1, wherein part of the control fluid which contacts the moveable member is a liquid.

11. A system according to claim 1, wherein the flow chamber comprises input and output ports between which the cryogenic fluid flows when in use.

12. A system according to claim 1, wherein the valve further comprises a control chamber for containing some of the control fluid, the control chamber being arranged in communication with a control device.

13. A system according to claim 12, wherein the control chamber has a variable volume in accordance with the pressure of the control fluid.

14. A system according to claim 13, wherein walls of the control chamber comprise bellows to effect the variable volume.

15. A system according to claim 12, wherein the movable member comprises a substantially rigid plate or disc which, in use, is arranged to be brought into contact with a wall of the flow chamber so as to control the flow in the flow chamber.

16. A system according to claim 15, wherein the moveable member is provided with a polymer layer upon its surface.

17. A system according to claim 12, wherein the moveable member is at least one flexible membrane which separates interiors of the flow and control chambers.

18. A system according to claim 17, wherein the flexible membrane is formed from polyimide.

19. A system according to claim 12, wherein the flow chamber comprises first and second connected flow sub-chambers between which the cryogenic fluid is arranged to flow, and wherein the control chamber comprises first and second corresponding connected control sub-chambers, each related to a respective flow sub-chamber, and wherein the moveable member comprises first and second corresponding flexible membranes, one membrane being provided to control the flow in each respective flow and control sub-chamber.

20. A system according to claim 19, wherein an input port opens into the first flow sub-chamber, an output port opens into the second flow sub-chamber and further comprising a flow conduit to effect the flow between the flow sub-chambers.

21. A system according to claim 19, wherein the first and second flow sub-chambers are arranged sandwiched between the first and second control sub-chambers.

22. A system according to claim 21, wherein the sub-chambers are located within a valve housing, and walls of the housing comprise walls of at least the first and second control sub-chambers.

23. A system according to claim 19, wherein the sub-chambers are arranged as discs.

24. A system according to claim 23, wherein the first and second flexible membranes are arranged as a disc.

25. A system according to claim 23, wherein a central part of the flexible membrane disc is stiffened with respect to an outer annular part.

26. A system according to claim 1, wherein the heater is an electrical heater.

27. A system according to claim 1, wherein the valve, moveable member and the adsorption pump are arranged such that the control fluid is retained within a closed system.

28. A system according to claim 1, wherein the length of the flow path of the cryogenic fluid is substantially longer than the distance between positions at which the cryogenic fluid enters and exits the valve.

29. A system according to claim 1, wherein operational pressure of the control fluid in use is between 50 and 500 kilopascals.

30. A system according to claim 1, further comprising a controller adapted to control the valve by controlling the heater of the adsorption pump.
